(19) United States
(12) Patent Application Publication
(10) Pub. No.: US 2002/0094512 A1
(43) Pub. Date: Jul. 18, 2002

(54) Computer controlled speech word recognition display dictionary providing user selection to clarify indefinite detection of speech words

(75) Inventors: Kulvir Singh Bhogal, Fort Worth, TX (US); Nizam Ishmael, JR., Austin, TX (US); Baljeet Singh Baweja, Austin, TX (US); Mandeep Sidhu, Austin, TX (US)

Correspondence Address: Jeffrey S. LaBaw, International Business Machines Corporation, Intellectual Property Law Department, 11400 Burnet Road, Internal Zip 4054, Austin, TX, 78758, US

(73) Assignee: International Business Machines Corporation

(21) Appl. No.: 09/726,011

(22) Filed: Nov. 29, 2000

(51) Int. Cl. G09B 5/00

(52) U.S. Cl. 434/169

(57) ABSTRACT

A computer controlled speech recognition display dictionary wherein the user may interactively clarify indefinitely detected speech words. There is provided a basic combination of a dictionary of recognizable speech words and the definitions of said words stored for said display dictionary, a routine for detecting said speech words and an implementation responsive to a definite detection of a speech word for displaying said word and the definition of the detected word. Now, in the case of an indefinite recognition, the invention provides an implementation responsive to an indefinite detection of a speech word for displaying a list of possible words approximating said detected word, enabling user selection of one of said displayed possible words and means responsive to a user selection of one of said displayed words for displaying the definition of the selected word.

### TECHNICAL FIELD

The present invention relates to interactive computer controlled display systems with speech recognition which provide display feedback to the interactive users, and particularly to the use of such systems for display dictionaries.

### BACKGROUND OF RELATED ART

Speech recognition technology has been available for over twenty years but it only recently has begun to find commercial acceptance, particularly with speech dictation or “speech to text” systems, such as those marketed by International Business Machines Corporation (IBM) and Dragon Systems. This aspect of the technology is now expected to have accelerated development until it has a substantial place in the word processing market. U.S. Pat. Nos. 5,890,122 and 6,088,671 are illustrative of current speech recognition-word processing technology.

One niche market for word processing speech recognition technology is the speech recognition dictionary. This technology involves a conventional computer display system with conventional speech recognition means. The display system is portable and preferably handheld. The interactive user speaks the speech word. If the system recognizes the speech word, its definition is displayed. When the system is portable, it is particularly useful in language interpretation or translation, i.e. the definitions of speech words are in a different language from the speech words.

### SUMMARY OF THE PRESENT INVENTION

While speech recognition dictionaries do provide a potentially valuable word processing tool, we have found that such dictionaries are prone to encounter a greater proportion of speech word recognition ambiguities, i.e. indefinite detection or recognition of speech words than conventional speech recognition systems which process long strings of spoken words. Such conventional speech recognition systems may employ a variety of creative software processes for each spoken word in a string based upon its context within the string and the syntax of the whole string. On the other hand, in a dictionary function, where there is only a single word or short phrase to try to recognize, there is no such benefit from the context or syntax environment.

Consequently, the present invention provides a computer controlled speech recognition display dictionary wherein the user may interactively clarify indefinitely detected speech words. There is provided a basic combination of a dictionary of recognizable speech words and the definitions of said words stored for said display dictionary, means for detecting said speech words and means responsive to a definite detection of a speech word for displaying said word and the definition of the detected word. Now, in the case of an indefinite recognition, the invention provides means responsive to an indefinite detection of a speech word for displaying a list of possible words approximating said detected word, means for user selection of one of said displayed possible words and means responsive to a user selection of one of said displayed words for displaying the definition of the selected word.

The invention can be effectively used where the definitions of said speech words are in a different language from said speech words for translation and interpretation. In such a use, the user may speak the word or he may ask the person speaking the other language to speak the word.

The dictionary may further include means responsive to a user selection of one of said displayed possible words for storing the displayed definition, in combination with means for treating all subsequent detections of the detected speech word as a definite detection of the selected word for displaying the stored definition of the selected word.

There is also provision for the addition of speech words to the dictionary through means for receiving a speech word not in said dictionary, means associated with the receiving means for enabling a user entry through the dictionary display of the definition of the received word and means for storing the received word and a user entered definition of the received word.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a generalized data processing system including a central processing unit which provides the computer controlled interactive display system with voice input which may be used in practicing the present invention;

FIG. 2 is a block diagram of a portion of the system of FIG. 1 showing a generalized expanded view of the system components involved in the implementation of the present invention;

FIG. 3 is a generalized block view of a conventional personal palm-type display device which may be set up to carry out the present invention;

FIG. 4 is a diagrammatic view of a display screen on a handheld display dictionary which shows a speech word definition displayed in response to a definite speech word recognition;

FIG. 5 is the display screen view of FIG. 4 after an indefinite speech word recognition;

FIG. 6 is the display screen view of FIG. 5 after the user has selected one of the words presented in FIG. 5 for definition; and

FIG. 7 is a flowchart of the steps involved in a typical run of the program of the present invention in handling of indefinite detection of speech words.

### DETAILED DESCRIPTION OF THE PREFERRED EMBODIMENT

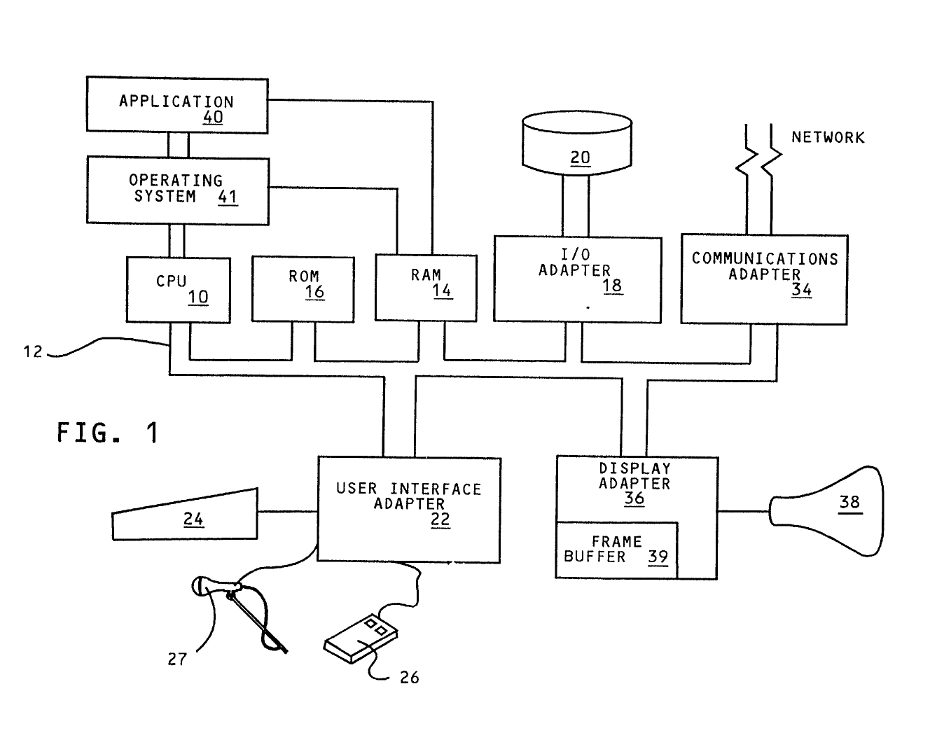

Referring to FIG. 1, a typical data processing system is shown which may function as the computer controlled display terminal used in implementing the display dictionary of the present invention by receiving speech words, detecting the definiteness of the words and providing the interactive user with the facility to clarify indefinite speech words. A central processing unit (CPU) 10, such as any PC microprocessor in a PC available from IBM or Dell Corp. is provided and interconnected to various other components by system bus 12. An operating system 41 runs on CPU 10, provides control and is used to coordinate the function of the various components of FIG. 1. Operating system 41 may be one of the commercially available operating systems such as Microsoft's Windows98™ or WindowsNT™. A program for recognizing speech words and for interactively clarifying indefinite words, application 40, to be subsequently described in detail, runs in conjunction with operating system 41 and provides output calls to the operating system 41 which implement the various functions to be performed by the application 40. A Read Only Memory (ROM) 16 is connected to CPU 10 via bus 12 and includes the Basic Input/Output System (BIOS) that controls the basic computer functions. Random Access Memory (RAM) 14, I/O adapter 18 and communications adapter 34 are also interconnected to system bus 12. It should be noted that software components, including operating system 41 and application 40, are loaded into RAM 14, which is the computer system's main memory. I/O adapter 18 may be a Small Computer System Interface (SCSI) adapter that communicates with the disk storage device 20, i.e. a hard drive. The word tables and their stored definitions are stored in disk storage, but are brought into RAM 14 as needed in the comparison, definition and interpretation of speech words to be hereinafter described in greater detail. Communications adapter 34 interconnects bus 12 with an outside network enabling the data processing system to communicate with other such systems over a Local Area Network (LAN) or Wide Area Network (WAN), which includes, of course, the Internet. I/O devices are also connected to system bus 12 via user interface adapter 22 and display adapter 36. Keyboard 24 and mouse 26 are all interconnected to bus 12 through user interface adapter 22.

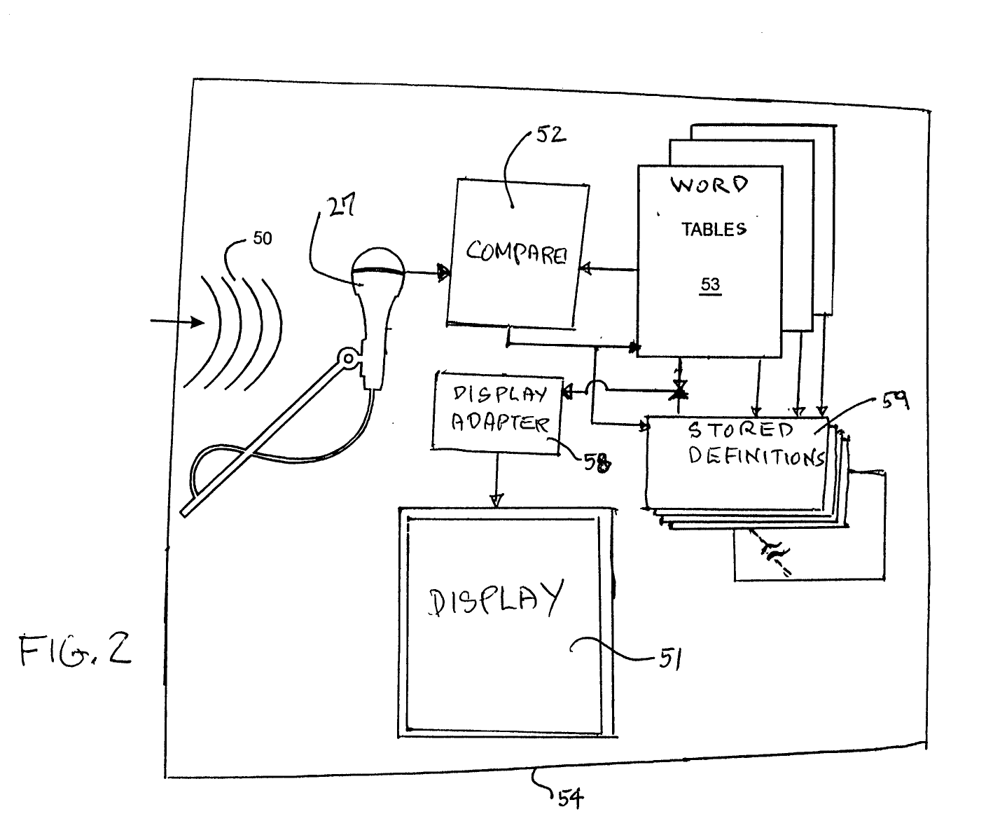

The speech input, which is made through input device 27, is diagrammatically depicted as a microphone accessing the system through an appropriate interface adapter 22. The speech input and recognition will subsequently be described in greater detail, particularly with respect to FIG. 2. Display adapter 36 includes a frame buffer 39, which is a storage device that holds a representation of each pixel on the display screen 38. Images such as speech input recognition panels, word definition and word clarification panels may be stored in frame buffer 39 for display on monitor 38 through various components, such as a digital to analog converter (not shown) and the like. By using the aforementioned I/O devices, a user is capable of inputting visual information to the system through the keyboard 24 or mouse 26 in addition to speech input through microphone 27, and receiving output information from the system via display 38.

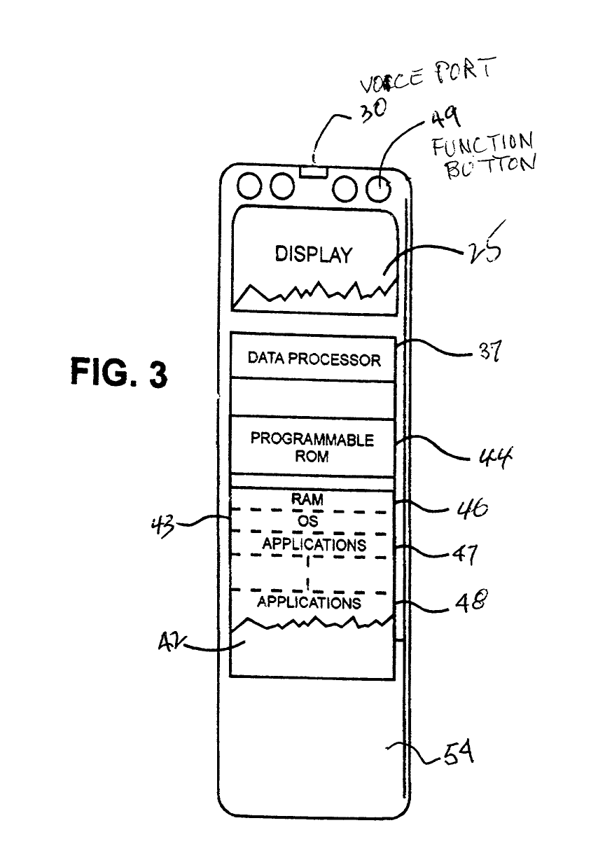

The present invention may also be implemented on personal palm type devices of the type shown in FIG. 3. Such devices are described in the text How to Do Everything with Your Palm Handheld, Dave Johnson et al., 2000, Osborne/McGraw-Hill, Berkeley, Calif. In FIG. 3, there is shown a very generalized diagram of the mobile personal palm type display device. It should be noted that the term “personal palm type display device” (PDA) is used to generally cover all varieties of palm type devices, which may be adaptable for use with the present invention. These include cellular phones and related wireless devices, smartphones and Internet screen phones. The most common PDAs included in the present generic definition “personal palm type devices” include Microsoft's WinCE line; the PalmPilot line produced by 3Com Corp.; IBM's WorkPad; and Motorola's Two Way Pager. These devices are comprehensively described in the basic text, Palm III & PalmPilot, Jeff Carlson, Peachpit Press, 1998, and in the text, Palm Handheld, Johnson and Brioda, Osborne/McGraw-Hill, New York, 2000. They contain a data processor 37, operating system 43, about two to four MB of RAM 46 and a permanent programmable memory, a programmable ROM 44, which may be an EPROM or flash ROM. Because these flash ROMs can now provide 4 MB of capacity, all of the application programs 47 through 48 stored on the personal palm device's RAM may now also be stored in the ROM 44. These would of course include the speech word detection and clarification programs of the present invention, to be subsequently described with respect to FIG. 2. Operating systems and built-in applications are also conventionally stored in the RAM. The word tables and stored definitions, to be subsequently described with respect to FIG. 2, are also stored in the RAM and ROM. Also, shown in the device is voice port 30 for receiving the speech words, function buttons 49 and a display screen 42, which is illustratively broken away to show the internal operating system and programs.

Now, with respect to FIG. 2 there will be described a display dictionary system for providing displayed definitions for definitely detected speech words and for interactively clarifying indefinitely detected speech words. The system is preferably housed within a handheld display device 54 as illustratively shown in FIG. 3. With respect to the general system components of FIG. 2, voice or speech input 50 is applied through microphone 27 which represents a speech input device. Since the art of speech terminology and speech command recognition is an old and well developed one, we will not go into the hardware and system details of a typical system, which may be used to implement the present invention. It should be clear to those skilled in the art that the systems and hardware in any of the following patents may be used: U.S. Pat. No. 6,088,671, U.S. Pat. No. 5,890,122, U.S. Pat. No. 5,671,328, U.S. Pat. No. 5,133,111, U.S. Pat. No. 5,222,146, U.S. Pat. No. 5,664,061, U.S. Pat. No. 5,553,121 and U.S. Pat. No. 5,157,384.

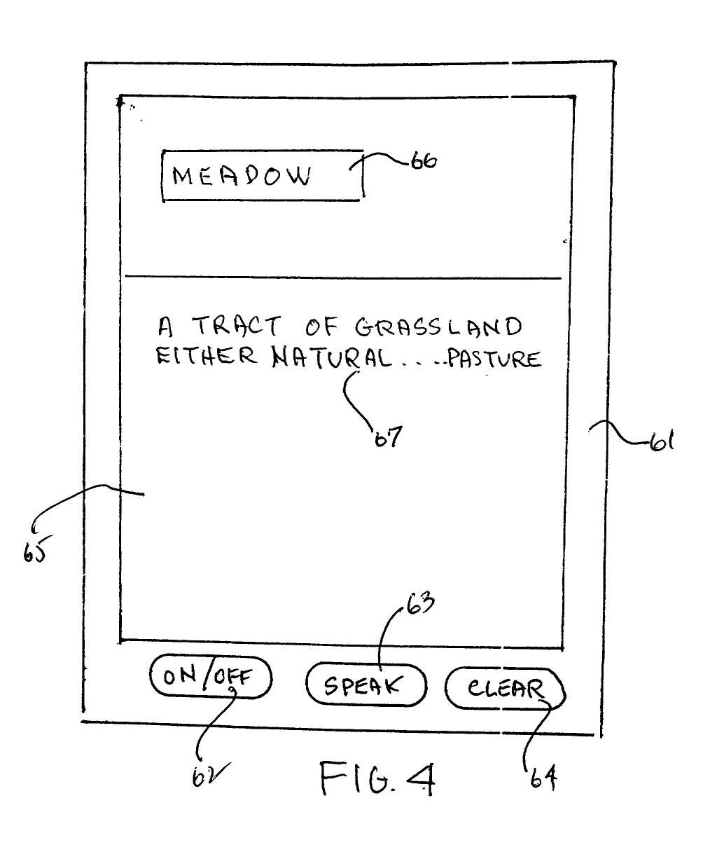

When the user wishes the definition of a particular word, he speaks that word to the system. The input speech goes through a recognition process which seeks a comparison 52 to a stored set of words which are stored in word tables 53. If an actual spoken word is clearly detected, the definition of that word is obtained from the stored definitions 59 and then displayed via display adapter 58 to display 51. Where the comparison results in no word from the word tables 53, that is even close to a compare, the system will display “not found”. However, because of the closeness of phonetics in speech words, the dictionary system comparison may come upon several words in the word tables which are close or even fit the comparison. The processing of such a situation provides the basis of the present invention and will now be discussed with respect to FIGS. 4 through 6.

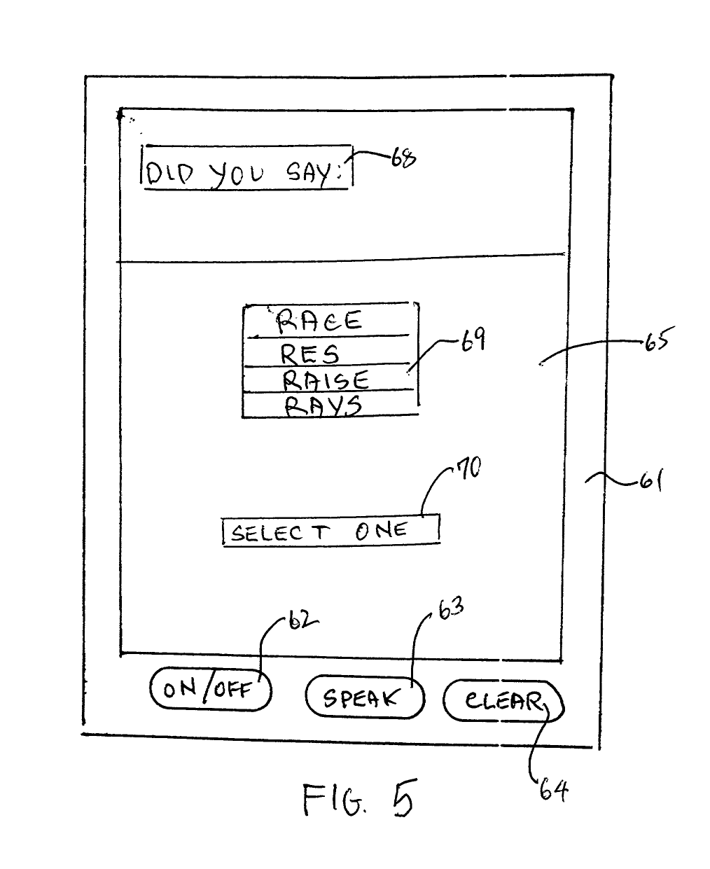

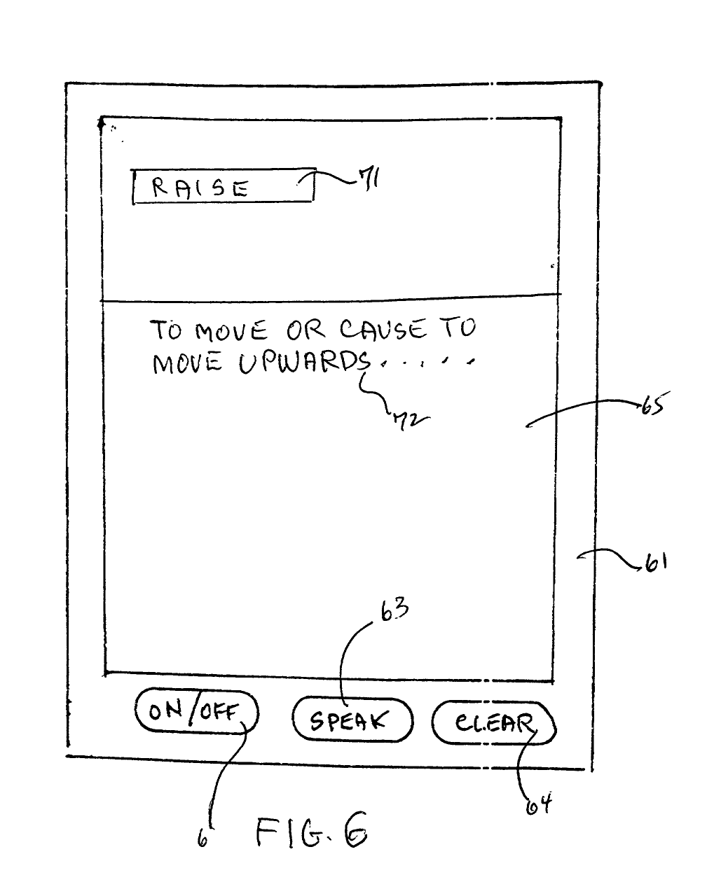

FIG. 4 illustrates the display device 61 after there has been a definite detection of a word, “MEADOW”, which is displayed 66 and its definition 67 displayed on screen 65. The device has an On/Off button 62, a speak button 63 and a clear button 64. FIG. 5 shows the display device 61 of FIG. 4, but after an indefinite detection of a word. The display dialog screen asks, “DID YOU SAY”, 68, and then presents a menu 69 of possible words approximating the detected word along with a displayed request 70 for the user to select the word that he meant to have defined. Conventional practices in the speech recognition technology as represented by the above-discussed prior art, provides techniques for generating words approximating a detection of a speech word. Any conventional technique for generating approximate words may be used to compile the list in menu 69. Then, as shown in FIG. 6, the user has selected the intended word, “RAISE”, 71, from the list and the resulting definition 72 is displayed.

This invention is applicable for conditions wherein the speech word is in a language different from the language of the needed definition. Under such conditions, the user may not be familiar enough with the language of the spoken or speech word to be able to select the displayed word that he wishes to have defined. In such a case, the dictionary may provide upon user request a display panel offering a short one or two word definition of each of the displayed possible words. For example, if a user whose primary language is English is trying to get the English definition of a German speech word, the following display may appear in FIG. 5:

DID YOU SAY:
GANZE-[Whole]
GANS-[Goose]
GANG-[Step]
- - -

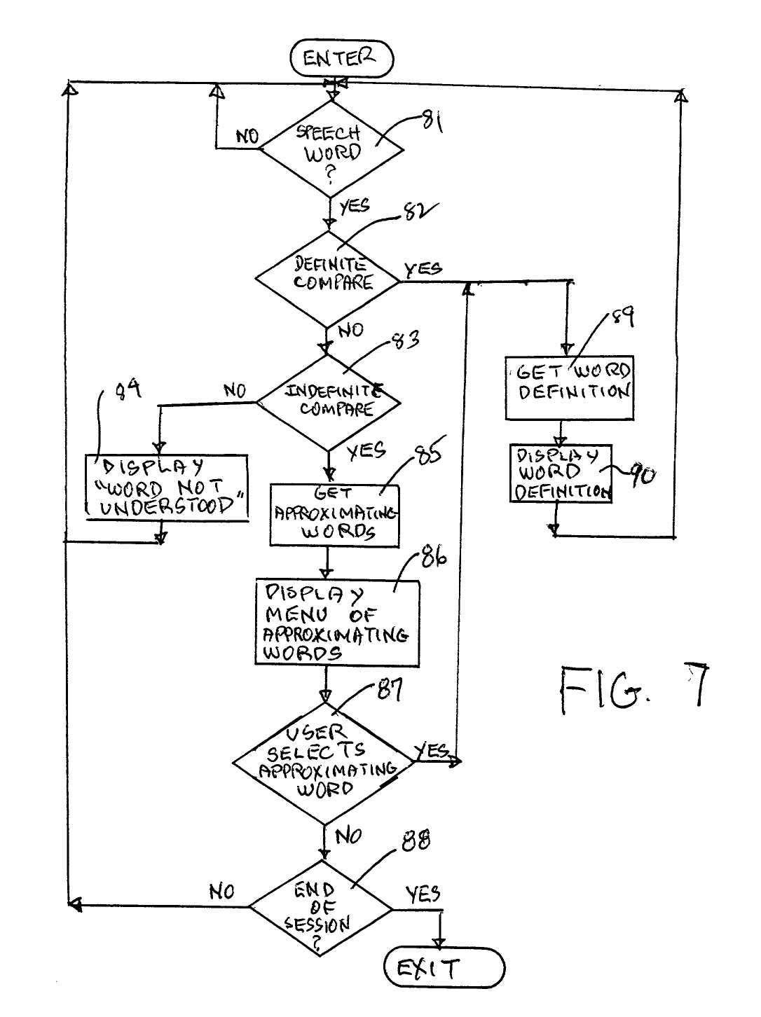

A run of a typical process in accordance with the present invention will now be described with respect to FIG. 7. An initial determination is made, step 81, as to whether there is an input of a speech word. If No, the process is to returned to step 81 and the input is awaited. If Yes, a comparison to the word tables is done and a further determination is made, step 82, as to whether there is a definite compare. If Yes, the definition of the word is obtained, step 89, and the definition of the word is displayed, step 90, after which the process is returned to initial step 81 where a new word input is awaited. If there is a No definite compare from step 82, then there is a determination made as to whether there is an indefinite compare, step 83. If No, then “WORD NOT UNDERSTOOD” is displayed, step 84, and the process is returned to step 81. If Yes, there is an indefinite compare, then the approximating words are obtained, step 85, and the menu of approximating words is displayed, step 86. A determination is then made as to whether the user has selected an approximating word, step 87. If Yes, the definition of the word is obtained, step 89, and the definition of the word is displayed, step 90, after which the process is returned to initial step 81 where a new word input is awaited. If the decision from step 87 is No, i.e. the speech word is not on the list, then, at this point, a determination may conveniently be made as to whether the user wishes to end the session. If Yes, the session is ended, or, if No, the process is returned to step 81 and the input is awaited.

It should be noted that where there has been a selection of a word from the list of approximate words on a indefinite compare, then the process may use conventional speech recognition heuristic means for treating all subsequent detections of that selected speech word as a definite detection of the selected word.

The present invention also provides for conventional adding of new words to the stored word tables and their definitions. This includes means for receiving a speech word not in said dictionary through the speech input, data I/O means for enabling a user entry through the dictionary display of the definition of said received word and means for storing said received word and a user entered definition of said received word.

One of the implementations of the present invention is as an application program 40 made up of programming steps or instructions resident in RAM 14, FIG. 1, during computer operations. Until required by the computer system, the program instructions may be stored in another readable medium, e.g. in disk drive 20, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention.

One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

1. A computer controlled display dictionary with speech word recognition comprising:
a dictionary of recognizable speech words and the definitions of said words stored for said display dictionary;
means for detecting said speech words;
means responsive to a definite detection of a speech word for displaying said word and the definition of the detected word;
means responsive to an indefinite detection of a speech word for displaying a list of possible words approximating said detected word;
means for user selection of one of said displayed possible words; and
means responsive to a user selection of one of said displayed words for displaying the definition of the selected word.

2. The computer controlled display dictionary of claim 1 wherein said definitions of said speech words are in a different language from said speech words.

3. The computer controlled display dictionary of claim 1 wherein said dictionary comprises a handheld display device.

4. The computer controlled display dictionary of claim 1 further including:
means responsive to said user selection of one of said displayed possible words for storing said displayed definition, and
means for treating all subsequent detections of said selected speech word as a definite detection of said selected word for displaying said stored definition of said selected word.

5. The computer controlled display dictionary of claim 1 further including means for adding speech words to said dictionary comprising:
means for receiving a speech word not in said dictionary,
means associated with said receiving means for enabling a user entry through the dictionary display of the definition of said received word, and
means for storing said received word and a user entered definition of said received word.

6. In a computer controlled display dictionary of recognizable speech words and the stored definitions of said words, a method for finding the definition of a speech word comprising;
detecting said speech word;
responsive to a definite detection of a speech word, displaying said detected word and the definition of the detected word;
responsive to an indefinite detection of a speech word, displaying a list of possible words approximating said detected word;
enabling user selection of one of said displayed possible words; and
responsive to a user selection of one of said displayed words, displaying the definition of the selected word.

7. The method of claim 6 wherein said definitions of said speech words are in a different language from said speech words.

8. The method of claim 6 wherein said dictionary is in a handheld display device.

9. The method of claim 6 further including the steps of:
responsive to said user selection of one of said displayed possible words, storing said displayed definition, and
treating all subsequent detections of said selected speech word as a definite detection of said selected word for displaying said stored definition of said selected word.

10. The method of claim 6 further including steps for adding speech words to said dictionary comprising:
receiving a speech word not in said dictionary,
enabling a user entry through the dictionary display of the definition of said received word, and
storing said received word and any user entered definition of said received word.

11. A computer program having code recorded on a computer readable medium for finding the definition of a speech word in a computer controlled display dictionary of recognizable speech words and the stored definitions of said words comprising:
means for detecting said speech words;
means responsive to a definite detection of a speech word for displaying said word and the definition of the detected word;
means responsive to an indefinite detection of a speech word for displaying a list of possible words approximating said detected word;
means for user selection of one of said displayed possible words; and
means responsive to a user selection of one of said displayed words for displaying the definition of the selected word.

12. The computer program of claim 11 wherein said definitions of said speech words are in a different language from said speech words.

13. The computer program of claim 11 wherein said dictionary comprises a handheld display device.

14. The computer program of claim 11 further including:
means responsive to said user selection of one of said displayed possible words for storing said displayed definition, and
means for treating all subsequent detections of said selected speech word as a definite detection of said selected word for displaying said stored definition of said selected word.

15. The computer program of claim 11 further including means for adding speech words to said dictionary comprising:
means for receiving a speech word not in said dictionary,
means associated with said receiving means for enabling a user entry through the dictionary display of the definition of said received word, and
means for storing said received word and a user entered definition of said received word.
